(19) United States
(12) Patent Application Publication
(10) Pub. No.: US 2026/0360302 A1
(43) Pub. Date: Nov. 12, 2026

(54) DISPLAY CONTROL METHOD, APPARATUS AND DEVICE FOR LED DISPLAY SCREEN AND STORAGE MEDIUM

(71) Applicant: GOERTEK INC., Weifang (CN)

(72) Inventors: Long JIANG, Weifang (CN); Guichuan CHEN, Weifang (CN)

(21) Appl. No.: 19/385,629

(22) Filed: Nov. 11, 2025

Related U.S. Application Data
(63) Continuation of application No. PCT/CN2024/103903, filed on Sep. 11, 2024.

(30) Foreign Application Priority Data
May 9, 2024 (CN) 202410566738.8

(51) Int. Cl. G09G 3/32

(52) U.S. Cl. CPC G09G 3/32; G09G 2360/147

(57) ABSTRACT

A display control method, an apparatus, device for an LED display screen, and a storage medium. The method includes: obtaining a pixel value of the LED display screen; determining a pixel density mask set representing different lighting states of the LED display screen based on the pixel value; scanning a pattern to be displayed through each of pixel density masks in the pixel density mask set to obtain a target display pattern; and controlling the LED display screen to perform a graduation display through the target display pattern.

### CROSS-REFERENCE TO RELATED APPLICATIONS

The present application is a continuation application of International Application No. PCT/CN2024/103903, filed on Sep. 11, 2024, which claims priority to Chinese Patent Application No. 202410566738.8, filed on May 9, 2024. The disclosures of the above-mentioned applications are incorporated herein by reference in their entireties.

### TECHNICAL FIELD

The present application relates to the technical field of display screen control, and in particular to a display control method, an apparatus, a device for an LED display screen, and a storage medium.

### BACKGROUND

Monochrome LED display screens are favored by developers in fields that do not require high-precision display, such as simple time display, due to their low price. However, monochrome LED display screens only have two states: lit and extinguished, which is relatively single and cannot be flexibly adjusted according to user's requirements.

### SUMMARY

The main purpose of the present application is to provide a display control method, an apparatus, device for an LED display screen, and a storage medium, aiming to solve the technical problem of the relatively single display of LED display screens in the related art.

To achieve the above purpose, the present application provides a display control method for an LED display screen. The method includes:
obtaining a pixel value of the LED display screen;
determining a pixel density mask set representing different lighting states of the LED display screen based on the pixel value;
scanning a pattern to be displayed through each of pixel density masks in the pixel density mask set to obtain a target display pattern; and
controlling the LED display screen to perform a graduation display through the target display pattern.

In an embodiment, the determining the pixel density mask set representing different lighting states of the LED display screen based on the pixel value includes:
determining a number of lit pixels through the pixel value;
classifying lighting states of the display screen based on the number of the lit pixels to obtain multiple lighting states of the display screen; and
constructing the pixel density mask set through the multiple lighting states of the display screen.

In an embodiment, the scanning the pattern to be displayed through each of the pixel density masks in the pixel density mask set to obtain the target display pattern includes:
obtaining summarized pixel coordinates based on each of the pixel density masks in the pixel density mask set;
scanning each of points in the pattern to be displayed through the pixel density mask and comparing pixels at same positions in the pattern to be displayed and the summarized pixel coordinates;
in response to that the pixel value of the corresponding pixel on the pattern to be displayed is a first value, using the pixel as a display pixel, the first value indicates that the pixel is displayed in a first state;
in response to that the pixel value of the corresponding pixel on the pattern to be displayed is a second value, skipping scanning the pixel until the scanning is completed to obtain a display pixel set, the second value indicates that the pixel is displayed in a second state, and the first state is different from the second state; and
obtaining the target display pattern through the display pixel set.

In an embodiment, the obtaining the pixel value of the LED display screen includes:
obtaining original pixels of the LED display screen;
dividing the original pixels to obtain multiple groups of divided pixels;
locating the multiple groups of the divided pixels based on a preset point-drawing function to obtain positions of the divided pixels; and
determining the pixel value of the LED display screen through the positions of the divided pixels.

In an embodiment, the locating the multiple groups of the divided pixels based on the preset point-drawing function to obtain the positions of the divided pixels includes:
locating each group of divided pixels in the multiple groups of the divided pixels based on the preset point-drawing function to obtain coordinates of the divided pixels; and
obtaining the positions of the divided pixels through the coordinates of the divided pixels.

In an embodiment, the determining the pixel value of the LED display screen through the positions of the divided pixels includes:
obtaining a preset value recording rule;
traversing the positions of the divided pixels to obtain different numbers of lit pixels in each group of divided pixels; and
recording a pixel value of a number of lit pixels based on the preset value recording rule to obtain the pixel value of the LED display screen.

In an embodiment, the controlling the LED display screen to perform the graduation display through the target display pattern includes:
obtaining a display instruction;
determining a density display timing sequence based on the display instruction; and
controlling display patterns with different display densities in the target display pattern to sequentially perform the graduation display on the LED display screen through the density display timing sequence.

In addition, to achieve the above purpose, the present application also provides a display control apparatus for the LED display screen, including:
an obtain module configured to obtain a pixel value of the LED display screen;
a determination module configured to determine a pixel density mask set representing different lighting states of the LED display screen based on the pixel value;
a scanning module configured to scan a to-be-displayed pattern through each of pixel density masks in the pixel density mask set to obtain a target display pattern; and
a display module configured to control the LED display screen to perform a graduation display through the target display pattern.

In addition, to achieve the above purpose, the present application also provides a display control device for the LED display screen, including a memory, a processor, and a computer program stored on the memory and operable on the processor. When the computer program is executed by the processor, the display control method for the LED display screen described above is implemented.

In addition, to achieve the above purpose, the present application also provides a storage medium. The storage medium is a computer-readable storage medium. A computer program is stored on the storage medium. When the computer program is executed by the processor, the display control method for the LED display screen described above is implemented.

In addition, to achieve the above purpose, the present application also provides a computer program product. The computer program product includes a computer program. When the computer program is executed by the processor, the display control method for the LED display screen described above is implemented.

One or more technical solutions provided in the present application have at least the following technical effects.

By determining the pixel density mask set in different lighting states of the display screen based on the pixel value, the to-be-displayed pattern can be scanned through different pixel density mask sets. The target display patterns with different display states can be obtained, and the LED display screen can be controlled to perform graduation display through these target display patterns. By adding a fade-in and fade-out effect to the display of the LED display screen, not only costs are reduced but also the display effect of the LED display screen is improved, which enhances the flexibility of display of the LED display screen and improves the user's experience.

### BRIEF DESCRIPTION OF THE DRAWINGS

The accompanying drawings are incorporated into the specification and form a part of the specification, which show embodiments consistent with the present application and are used to explain the principles of the present application with reference to the specification.

To clearly illustrate the embodiments of the present application or the technical solutions in the related art, the following briefly introduces the accompanying drawings required for describing the embodiments or the related art. Obviously, for those skilled in the art, other accompanying drawings can be obtained based on these drawings without creative efforts.

FIG. 1 is a schematic flowchart of a display control method for an LED display screen according to an embodiment of the present application.

FIG. 2 is a schematic display diagram of a monochrome LED display screen of the display control method for the LED display screen according to an embodiment of the present application.

FIG. 3 is a schematic diagram of dividing original pixels into multiple groups of divided pixels of the display control method for the LED display screen according to an embodiment of the present application.

FIG. 4 is a schematic diagram of a process of locating divided pixels to obtain coordinates of the divided pixels of the display control method for the LED display screen according to an embodiment of the present application.

FIG. 5 is a schematic diagram of superimposing a to-be-displayed pattern and a 50% grayscale mask at a monochrome LED display screen of the display control method for the LED display screen according to an embodiment of the present application.

FIG. 6 is a schematic flowchart of the display control method for the LED display screen according to an embodiment of the present application.

FIG. 7 is a schematic diagram of different lighting states of divided pixels of the display control method for the LED display screen according to an embodiment of the present application.

FIG. 8 is a schematic diagram of display effects with different pixel densities of the display control method for the LED display screen according to an embodiment of the present application.

FIG. 9 is a schematic flowchart of the display control method for the LED display screen according to an embodiment of the present application.

FIG. 10 is a schematic diagram of target display pattern effects obtained by superimposing grayscale masks with different pixel densities of the display control method for the LED display screen according to an embodiment of the present application.

FIG. 11 is a simplified schematic flowchart of the display control method for the LED display screen according to an embodiment of the present application.

FIG. 12 is a module structural diagram of a display control apparatus of the LED display screen according to an embodiment of the present application.

FIG. 13 is an device structural diagram of a hardware operating environment involved in the display control method for the LED display screen according to an embodiment of the present application.

The realization of the objective, functional characteristics, and advantages of the present application are further described in conjunction with the embodiments and with reference to the accompanying drawings.

### DETAILED DESCRIPTION OF THE EMBODIMENTS

It should be understood that the specific embodiments described herein are only used to explain the technical solutions of the present application and are not intended to limit the present application.

To better understand the technical solutions of the present application, the following detailed descriptions are provided with reference to the accompanying drawings and specific implementations.

The main solution of the present application is: obtaining the pixel value of the LED display screen; determining the pixel density mask set representing different lighting states of the LED display screen based on the pixel value; scanning the to-be-displayed pattern based on each pixel density mask in the pixel density mask set to obtain the target display pattern; and controlling the LED display screen to perform graduation display through the target display pattern.

In this embodiment, for the convenience of description, the display control device for the LED display screen is taken as the execution subject for elaboration.

In the related art, monochrome LED display screens only have two states: lit and extinguished, which cannot flexibly adjust the display interface of the display screen according to user's needs. If graduation display is required for the display screen, a multi-color LED display screen is needed. However, multi-color display screens have high costs, and monochrome LED display screens alone cannot flexibly adjust the display according to user's needs.

The present application provides a solution to add a fade-in and fade-out effect to the display of the monochrome LED display screens, which reduces display costs while improving the user's experience.

From the above embodiments, it can be seen that the present application obtaines the pixel value of the LED display screen; determines the pixel density mask set representing different lighting states of the LED display screen based on the pixel value; scans the to-be-displayed pattern based on each pixel density mask in the pixel density mask set to obtain the target display pattern; and controls the LED display screen to perform graduation display through the target display pattern. This overcomes the technical problems of single display and insufficient flexibility of monochrome LED display screens. Thus, the present application adds fade-in and fade-out effect to the display, reduces costs, improves the display effect of the LED display screen, and enhances the user's experience.

It should be noted that the execution subject of the present application may be a computing service device with data processing, network communication, and program running functions, such as a tablet computer, a personal computer, a mobile phone, etc. Alternatively, it may be an electronic device, a display control device for the LED display screen that can achieve the above functions. Hereinafter, the display control device for the LED display screen is taken as an example to describe this embodiment and the following embodiments.

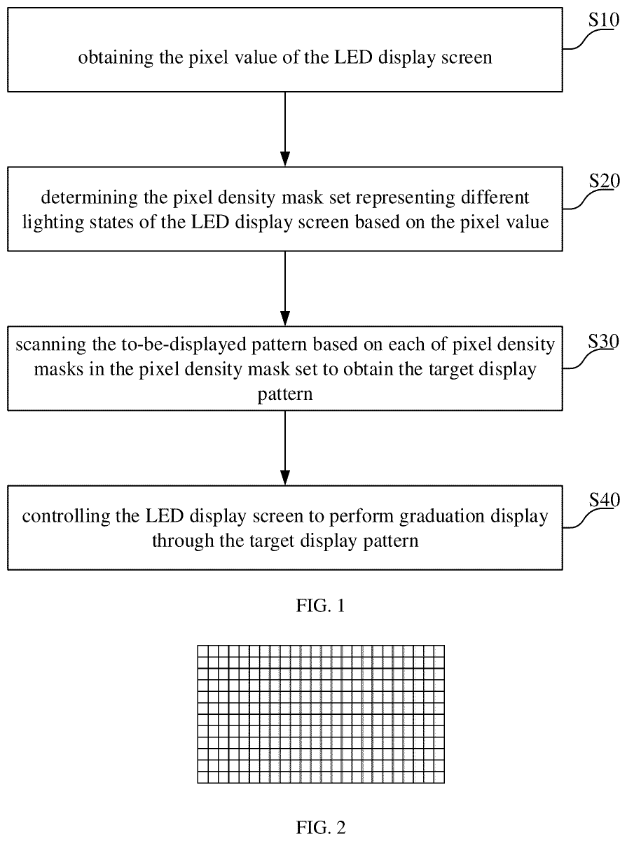

Based on this, the present application provides a display control method for an LED display. Referring to FIG. 1, FIG. 1 is a schematic flowchart of a display control method for an LED display screen according to an embodiment of the present application.

In this embodiment, the display control method for the LED display screen includes steps S10 to S40.

Step S10, obtaining the pixel value of the LED display screen.

It should be noted that the LED display screen is a monochrome LED display screen, such as a fixed monochrome LED display screen used to display static or scrolling text information, graphics, or simple animations, or a flexible monochrome LED display screen.

The pixel value of the monochrome LED display screen may be the value of each pixel at the monochrome LED display screen. The pixel value can be recorded by constructing a display array. The extinguished value is defined as 0, and the lit value is defined as 1. The pixels in the monochrome LED display screen can be divided, and the pixel values of the divided pixels can be obtained.

In addition, to achieve the fade-in and fade-out effect, the pixels in the LED display screen can be redivided.

In an embodiment, step S10 includes steps A11 to A14.

Step A11, obtaining the original pixels of the LED display screen.

It should be noted that the original pixels are the undivided pixels at the monochrome LED display screen.

As shown in FIG. 2, FIG. 2 is a schematic display diagram of a monochrome LED display screen. The monochrome LED display screen is composed of multiple pixels, i.e., original pixels. Each pixel only has the function of being lit and extinguished.

To achieve the fade-in and fade-out display effect, this embodiment redivides the original pixels.

Step A12, dividing the original pixels to obtain multiple groups of divided pixels.

It should be noted that when dividing the original pixels, a division rule can be set, such as the number of new pixels in each group. For example, the number of new pixels in each group can be four, six, eight, etc., which can be adjusted according to specific needs. The more the number of new pixels in each group, the more detailed the constructed pixel density mask.

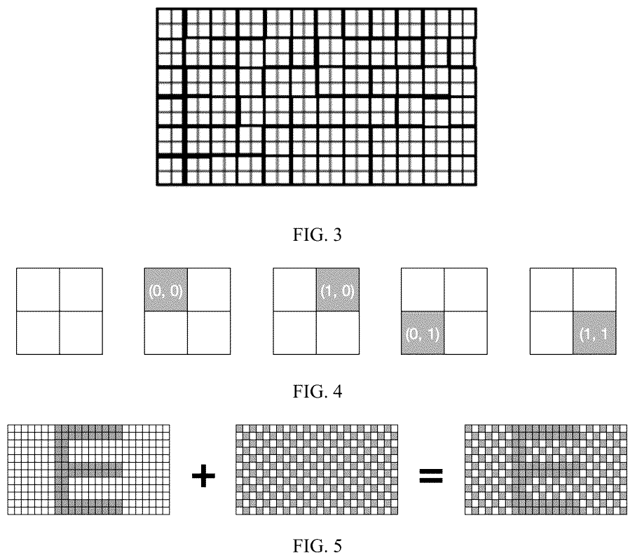

For example, if the division rule is that each group has four new pixels, the original pixels are divided into groups of four, and each group is a divided pixel, thereby obtaining multiple groups of divided pixels. As shown in FIG. 3, FIG. 3 is a schematic diagram of dividing original pixels into multiple groups of divided pixels. Every four adjacent pixels (in a grid) form a group of pixels, resulting in multiple groups of divided pixels.

Step A13, locating the multiple groups of divided pixels based on the preset point-drawing function to obtain the positions of the divided pixels.

It can be understood that the preset point-drawing function can be constructed through C language. The preset point-drawing function Point (x, y) is used to locate each pixel in the divided pixels. Each group of divided pixels can be located separately to quickly determine the positions of the divided pixels.

Further, the step of locating the multiple groups of divided pixels based on the preset point-drawing function to obtain the positions of the divided pixels includes: locating each group of divided pixels in the multiple groups of divided pixels based on the preset point-drawing function to obtain the coordinates of the divided pixels; and obtaining the positions of the divided pixels through the coordinates of the divided pixels.

It should be noted that each group of divided pixels can be divided into coordinates to obtain the coordinates of each of the divided pixels in the group. The positions of the divided pixels can be quickly obtained through the coordinates of the divided pixels. As shown in FIG. 4, FIG. 4 is a schematic diagram of a process of locating divided pixels to obtain coordinates of the divided pixels. For example, a divided pixel includes four pixels. By dividing each pixel into coordinates as (0, 0) for the upper left corner, (1, 0) for the upper right corner, (0, 1) for the lower left corner, and (1, 1) for the lower right corner. By analogy, the positions of all divided pixels in the monochrome display screen can be obtained.

Step A14, determining the pixel value of the LED display screen through the positions of the divided pixels.

It should be noted that the pixel value of each of the divided pixels in the LED display screen can be determined through the positions of the divided pixels.

Specifically, a rule for recording pixel values can be set in advance to quickly determine the pixel values of each of the divided pixels. Then, the step of determining the pixel value of the LED display screen through the positions of the divided pixels includes:
obtaining a preset value recording rule; traversing the positions of the divided pixels to obtain the different number of lit pixels in each group of the divided pixels; and recording the pixel value of the number of lit pixels through the preset value recording rule to obtain the pixel value of the LED display screen.

It should be noted that the preset value recording rule is for defining the recording of pixel values. A display array Show[n] can be constructed to record the current pixel value. The extinguished value is defined as zero, and the lit value is defined as one. By traversing the positions of the divided pixels, the different number of lit pixels in each group of the divided pixels can be obtained. For example, the divided pixel has four pixels, and the number of lit pixels can include five types: all extinguished (zero lit pixels), only one pixel lit (one lit pixel), two pixels lit (two lit pixels), three pixels lit (three lit pixels), and all lit (four lit pixels). The pixel value of each of the divided pixels is obtained through the different number of lit pixels, thereby obtaining the pixel values of all pixels in the LED display screen.

Step S20, determining the pixel density mask set representing different lighting states of the LED display screen based on the pixel value.

It should be noted that the number of lit pixels can be determined through the pixel value. According to the different number of lit pixels, the pixel density mask set representing different lighting states of the LED display screen can be obtained.

The pixel density mask set includes masks with different pixel densities. The pixel density mask is also a grayscale mask. For example, the pixel density mask set includes a mask with a pixel density of 0% (all pixels on the display screen are extinguished, and the pixel values are all 0), a mask with a pixel density of 50%, or a mask with a pixel density of 100%, etc. The number of grayscale masks can be determined based on the number of divided pixels based on the pixel division rule. For example, the number of the divided pixels is n, and there are n−1 types of grayscale masks.

Step S30, scanning the to-be-displayed pattern based on each of pixel density masks in the pixel density mask set to obtain the target display pattern.

In an embodiment, the pixel density mask set contains masks with different pixel densities. The to-be-displayed pattern can be scanned through different pixel density masks to obtain a new scanned pattern.

The to-be-displayed pattern is the pattern that the user needs to display on the monochrome LED display screen. By superimposing the to-be-displayed pattern with the corresponding pixel density mask, the corresponding display pattern can be obtained. As shown in FIG. 5, FIG. 5 is a schematic diagram of superimposing the to-be-displayed pattern and a 50% grayscale mask at a monochrome LED display screen. For example, the to-be-displayed pattern of the current monochrome LED display screen is a capital letter “E”, which can be overlapped with a grayscale mask with a pixel density of 50%. It can be found that some pixels of the display screen pattern are overlapped with the grayscale mask. Multiple target display patterns can be obtained by superimposing and scanning the to-be-displayed pattern with grayscale masks of different pixel densities.

Step S40, controlling the LED display screen to perform graduation display through the target display pattern.

In an embodiment, the LED display screen can be controlled to perform graduation display through the target display pattern. The graduation display refers to controlling the monochrome LED display screen to perform fade-in and fade-out display.

Further, different displays can be performed according to different requirements of the user. Then step S40 includes:
obtaining a display instruction, determining a density display timing sequence based on the display instruction, and controlling the display patterns with different display densities in the target display pattern to sequentially perform graduation display on the LED display screen through the density display timing sequence.

It can be understood that the display instruction can include the display density of the target display pattern from high to low or from low to high, which can be selected according to specific needs.

In an embodiment, the density display timing sequence can be determined by analyzing the display instruction. For example, if the density display timing sequence is from low to high, the display pattern with low display density in the target display pattern can be controlled to be displayed on the LED display screen first through the density display timing sequence, and the display pattern with high display density in the target display pattern can be controlled to be displayed later on the LED display screen.

To achieve the fade-in and fade-out effect, a grayscale function Gray(x) can be established. The values in the video memory array Show[n] in different grayscale masks, i.e., the target display patterns with different pixel densities, are sequentially called through the grayscale function Gray(x). For example, to achieve the effect from nothing to something, the target display patterns can be sequentially displayed according to the following pixel density masks: 0%→25%→50%→75%→100%. To achieve the effect from something to nothing, the target display patterns can be sequentially displayed according to the following pixel density masks: 100%→75%→50%→25%→0%.

In this embodiment, the pixel value of the LED display screen is obtained first. Then, the pixel density mask set representing different lighting states of the LED display screen is determined based on the pixel value. Next, the to-be-displayed pattern is scanned through each of the pixel density masks in the pixel density mask set to obtain the target display pattern. Finally, the LED display screen is controlled to perform graduation display through the target display pattern. The to-be-displayed pattern can be scanned through the pixel density mask set, and a fade-in and fade-out effect is added to the display. This not only reduces costs but also improves the display effect of the LED display screen and enhances the user's experience.

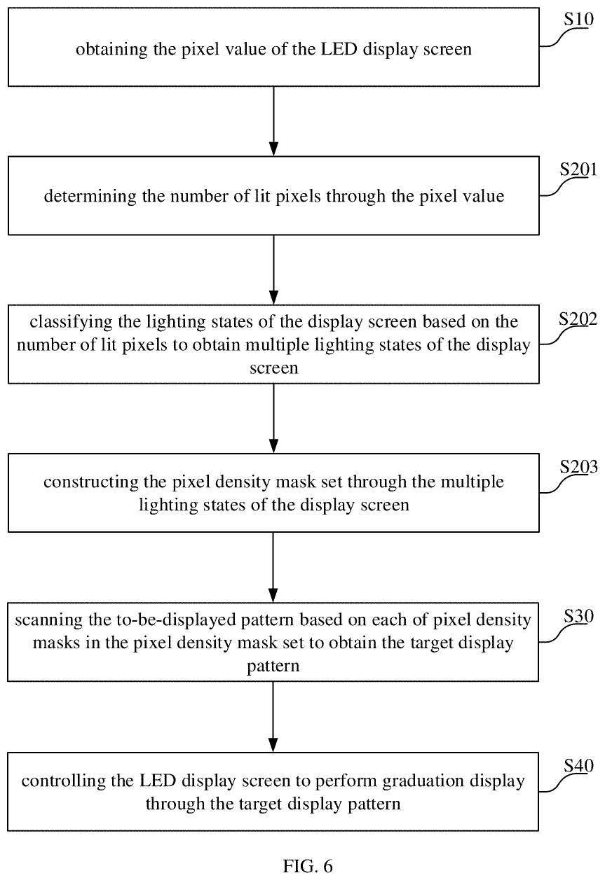

Referring to FIG. 6, step S20 includes:

Step S201, determining the number of lit pixels through the pixel value.

It should be noted that the number of lit pixels can be determined through the pixel value. For example, the pixel value is zero, and the number of lit pixels is zero; the pixel values in each group of divided pixels are one, zero, zero, zero respectively, and the number of lit pixels is one.

By analogy, the number of lit pixels can be determined based on the pixel values in each group of divided pixels.

Step S202, classifying the lighting states of the display screen based on the number of lit pixels to obtain multiple lighting states of the display screen.

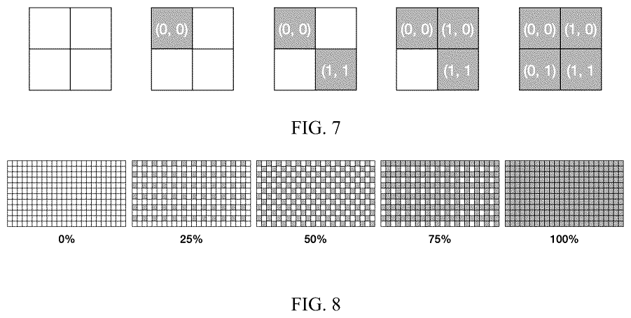

In an embodiment, the lighting states of the display screen can be classified based on the number of lit pixels to obtain multiple lighting states of the display screen. As shown in FIG. 7, FIG. 7 is a schematic diagram of different lighting states of divided pixels. The lighting states can be divided into five states based on the different number of lit pixels among the four pixels in the divided pixel: all extinguished; only one pixel lit (0, 0); two pixels lit (0, 0) and (1, 1); three pixels lit (0, 0), (1, 0), and (1, 1); and all lit (0, 0), (1, 0), (1, 1), and (0, 1).

Step S203, constructing the pixel density mask set through the multiple lighting states of the display screen.

In an embodiment, if the entire display screen is filled with the above multiple lighting states, visual effects with different pixel densities, i.e., grayscale masks, can be obtained. The pixel density mask set can be obtained by summarizing the grayscale masks with different pixel densities.

In an embodiment, if the lighting states of each group of divided pixels include five states: all extinguished, only one pixel lit, two pixels lit, three pixels lit, and all lit, the obtained pixel densities are 0%, 25%, 50%, 75%, and 100%. As shown in FIG. 8, FIG. 8 is a schematic diagram of display effects with different pixel densities. From left to right, they are the pixel density of 0% corresponding to all extinguished, 25% corresponding to only one pixel lit, 50% corresponding to two pixels lit, 75% corresponding to three pixels lit, and 100% corresponding to all lit.

In this embodiment, the number of lit pixels is determined through the pixel value. The lighting states of the display screen are classified based on the number of lit pixels to obtain multiple lighting states of the display screen. The pixel density mask set is constructed through the multiple lighting states of the display screen. This allows grayscale masks with different pixel densities to be quickly constructed based on the pixel value, so that different display effects of the display screen can be achieved through the grayscale masks without changing the hardware structure of the display screen, thereby reducing costs.

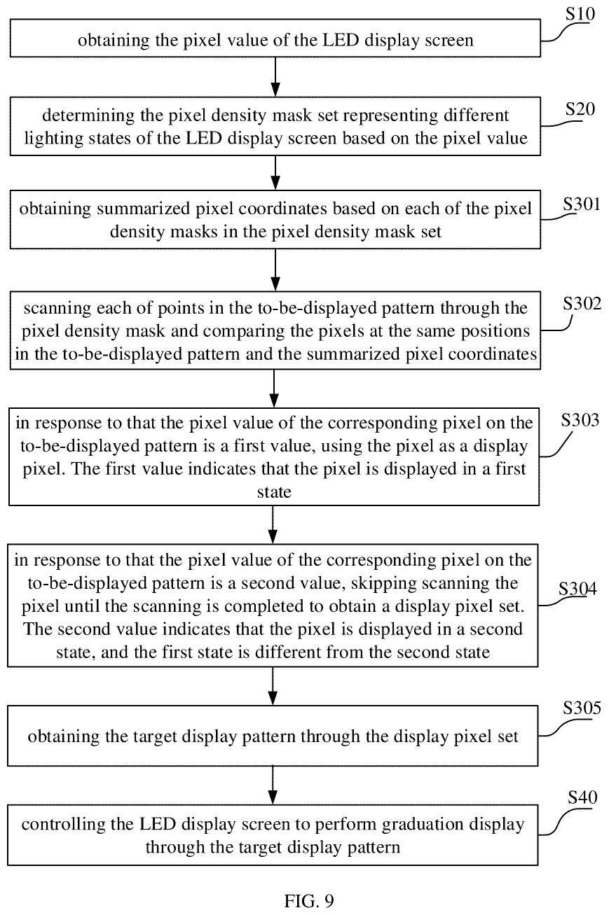

Referring to FIG. 9, step S30 includes:

Step S301, obtaining summarized pixel coordinates based on each of the pixel density masks in the pixel density mask set.

It should be noted that different pixel density masks can be obtained based on the pixel density mask set. Each of the pixel density masks can be counted to obtain the coordinates of each of the pixels in each of the pixel density masks. All pixel coordinates are summarized to obtain the summarized pixel coordinates.

Step S302, scanning each of points in the to-be-displayed pattern through the pixel density mask and comparing the pixels at the same positions in the to-be-displayed pattern and the summarized pixel coordinates.

In an embodiment, each of the points in the to-be-displayed pattern is scanned separately through different pixel density masks. The pixels at the same positions on the to-be-displayed pattern and the summarized pixel coordinates are compared.

For example, each of the pixel coordinates on the 50% grayscale mask is used as the object for scanning one by one, and compared with the pixel at the same position on the to-be-displayed pattern.

Step S303, in response to that the pixel value of the corresponding pixel on the to-be-displayed pattern is a first value, using the pixel as a display pixel. The first value indicates that the pixel is displayed in a first state.

During the comparison, if the pixel value of the corresponding pixel on the to-be-displayed pattern is the first value, the pixel can be used as a display pixel. The first value is one, and the corresponding pixel state should be the lighting state. The display pixel is the lit point in the display pattern during subsequent display.

In an embodiment, the first value indicates that the pixel is displayed in the first state, and the first state is the lighting state.

Step S304, in response to that the pixel value of the corresponding pixel on the to-be-displayed pattern is a second value, skipping scanning the pixel until the scanning is completed to obtain a display pixel set. The second value indicates that the pixel is displayed in a second state, and the first state is different from the second state.

During the comparison, if the pixel value of the corresponding pixel on the to-be-displayed pattern is the second value, scanning this pixel is skipped. The second value is zero, and the corresponding pixel state should be the extinguished state. The second state is the extinguished state.

By comparing each pixel on the to-be-displayed pattern with each pixel on the pixel density mask, all pixels are scanned. The pixels are filtered to obtain the display pixel set.

Step S305, obtaining the target display pattern through the display pixel set.

In an embodiment, a new display pattern, i.e., the target display pattern, can be constructed through the display pixel set.

By superimposing the grayscale masks with different pixel densities on the to-be-displayed pattern, display patterns with different pixel densities can be constructed, and finally, target display patterns with multiple pixel densities can be obtained.

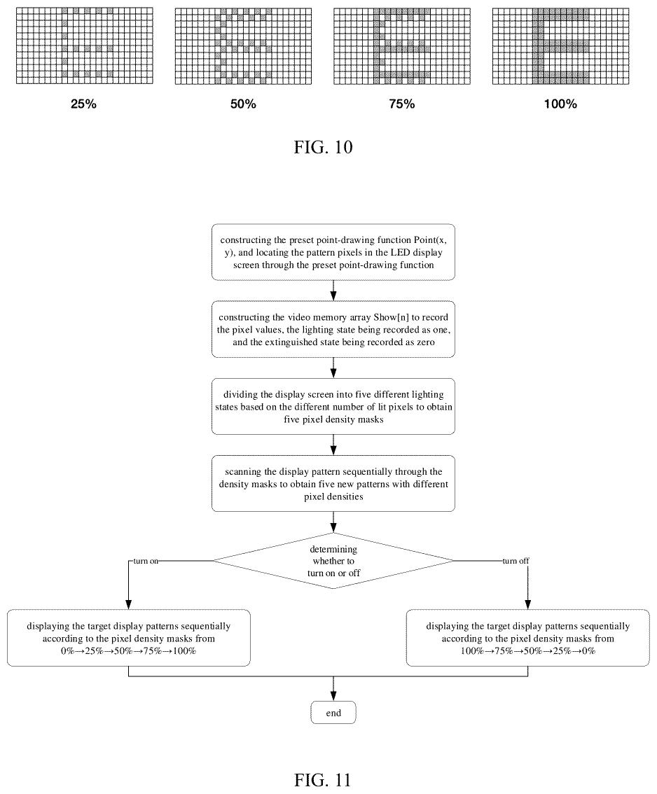

For example, each of the pixel coordinates on the 50% grayscale mask is used as the object for scanning one by one and compared with the to-be-displayed pattern “E”. If the value of the corresponding pixel on the display pattern is zero (extinguished state), this point is skipped and the scanning continues. If the value of the corresponding pixel is one (lighting state), this point is used as a display pixel. A point can also be drawn at the same coordinate position through the point-drawing function Point (x, y) in the video memory array Show[n]. When all points corresponding to the to-be-displayed pattern on the display screen are scanned, all overlapping pixel coordinates on the grayscale mask and the to-be-displayed pattern are stored in the video memory array Show[n] in the form of value one. Thus, a target display pattern with a pixel density of 50% is obtained. Similarly, by superimposing and scanning with other grayscale masks with different pixel densities, three other patterns with pixel densities of 25%, 75%, and 100% can be obtained. As shown in FIG. 10, FIG. 10 is a schematic diagram of target display pattern effects obtained by superimposing grayscale masks with different pixel densities. From left to right, they are the target display pattern with a pixel density of 25%, 50%, 75%, and 100%.

In this embodiment, summarized pixel coordinates are obtained based on each of the pixel density masks in the pixel density mask set. Each of the points in the to-be-displayed pattern is scanned through the pixel density mask, and the pixels at the same positions in the to-be-displayed pattern and the summarized pixel coordinates are compared. When the pixel value of the corresponding pixel on the to-be-displayed pattern is the first value, the pixel is used as a display pixel, and the first value indicates that the pixel is displayed in the first state. When the pixel value of the corresponding pixel on the to-be-displayed pattern is the second value, scanning the pixel is skipped until the scanning is completed to obtain the display pixel set. The second value indicates that the pixel is displayed in the second state, and the first state is different from the second state. The target display pattern is obtained through the display pixel set. This allows the grayscale masks with different pixel densities to be quickly scanned with the to-be-displayed pattern, thereby obtaining multiple target display patterns with different display densities and improving the display effect of the pattern.

To facilitate understanding the implementation process of the display control method for the LED display screen obtained by combining the above embodiment, referring to FIG. 11, FIG. 11 provides a simplified schematic flowchart of the display control method for the LED display screen. Specifically, constructing the preset point-drawing function Point(x, y), and locating the pattern pixels in the LED display screen through the preset point-drawing function; constructing the video memory array Show[n] to record the pixel values, the lighting state being recorded as one, and the extinguished state being recorded as zero; dividing the display screen into five different lighting states based on the different number of lit pixels to obtain five pixel density masks; scanning the display pattern sequentially through the density masks to obtain five new patterns with different pixel densities; determining whether the user's instruction is to turn on or off; if it is to turn on, displaying the target display patterns sequentially according to the pixel density masks from 0%→25%→50%→75%→100%; and if it is to turn off, displaying the target display patterns sequentially according to the pixel density masks from 100%→75%→50%→25%→0%.

It should be noted that the above example is only used to understand the present application and does not constitute a limitation on the display control method for the LED display screen of the present application. More simple transformations based on this technical concept are all within the scope of the present application.

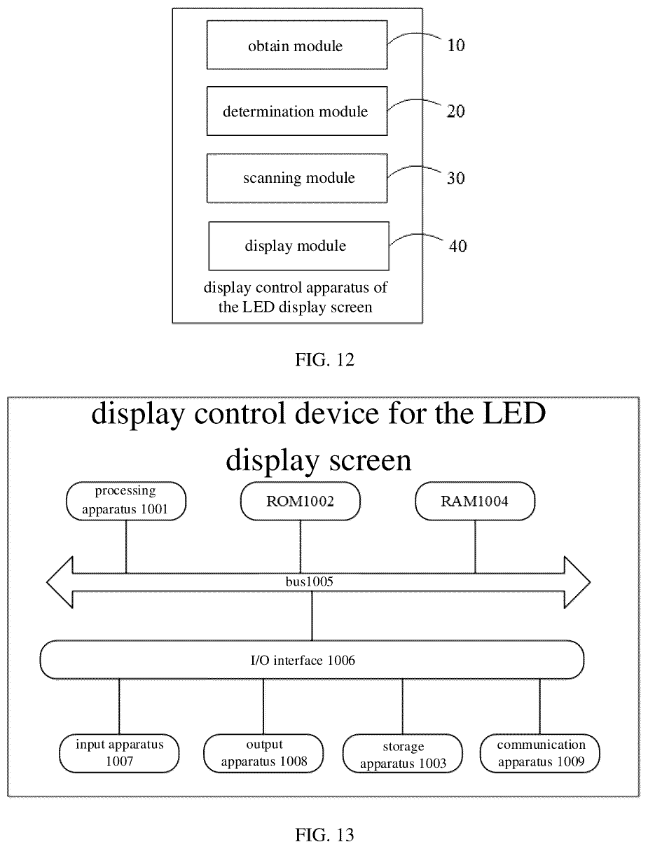

The present application also provides a display control apparatus of the LED display screen. Referring to FIG. 12, the display control apparatus of the LED display screen includes an obtain module 10, a determination module 20, a scanning module 30 and a display module 40.

The obtain module 10 is configured to obtain the pixel value of the LED display screen.

The determination module 20 is configured to determine the pixel density mask set representing different lighting states of the LED display screen based on the pixel value.

The scanning module 30 is configured to scan the to-be-displayed pattern through each of the pixel density masks in the pixel density mask set to obtain the target display pattern.

The display module 40 is configured to control the LED display screen to perform graduation display through the target display pattern.

The display control apparatus of the LED display screen provided by the present application adopts the display control method for the LED display screen in the above embodiment and can solve the technical problem of the relatively single display of LED display screens in the related art. Compared with the related art, the beneficial effects of the display control apparatus of the LED display screen provided by the present application are the same as those of the display control method for the LED display screen provided by the above embodiment. Other technical features in the display control apparatus for the LED display screen are the same as those disclosed in the method of the above embodiment, which will not be repeated here.

The present application provides a display control device for the LED display screen. The display control device for the LED display screen includes: at least one processor; and a memory communicatively connected to the at least one processor. The memory stores instructions executable by the at least one processor. The instructions are executed by the at least one processor to enable the at least one processor to execute the display control method for the LED display screen in the above embodiments.

Referring to FIG. 13, which shows a schematic structural diagram of a display control device for the LED display screen suitable for implementing the embodiments of the present application. The display control device for the LED display screen in the embodiments of the present application includes, but is not limited to, mobile terminals such as mobile phones, notebook computers, digital broadcast receivers, personal digital assistants (PDAs), portable application description (PADs), portable media players (PMPs), in-vehicle terminals (such as in-vehicle navigation terminals), etc., and fixed terminals such as digital TVs, desktop computers, etc. The display control device for the LED display screen shown in FIG. 13 is only an example and should not impose any limitation on the functions and scope of use of the embodiments of the present application.

As shown in FIG. 13, the display control device for the LED display screen includes a processing apparatus 1001 (such as a central processing unit, a graphics processor, etc.). It can execute various appropriate actions and processes according to the program stored in a read-only memory (ROM) 1002 or the program loaded into a random access memory (RAM) 1004 from a storage apparatus 1003. Various programs and data required for the operation of the display control device for the LED display screen are also stored in the RAM 1004. The processing apparatus 1001, the ROM 1002, and the RAM 1004 are connected to each other through a bus 1005. An input/output (I/O) interface 1006 is also connected to the bus 1005. Generally, the following systems can be connected to the I/O interface 1006: an input apparatus 1007 including, for example, a touch screen, a touch pad, a keyboard, a mouse, an image sensor, a microphone, an accelerometer, a gyroscope, etc.; an output apparatus 1008 including, for example, a liquid crystal display (LCD), a speaker, a vibrator, etc.; a storage apparatus 1003 including, for example, a magnetic tape, a hard disk, etc.; and a communication apparatus 1009. The communication apparatus 1009 can allow the display control device for the LED display screen to perform wireless or wired communication with other device to exchange data. Although FIG. 13 shows a display control device for the LED display screen with various systems, it should be understood that it is not required to implement or have all the shown systems. It can alternatively implement or have more or fewer systems.

In particular, according to the disclosed embodiments of the present application, the processes described above with reference to the flowcharts can be implemented as computer software programs. For example, the disclosed embodiments of the present application include a computer program product. It includes a computer program carried on a computer-readable medium. The computer program contains program code for executing the method shown in the flowchart. In such an embodiment, the computer program can be downloaded and installed from the network through the communication apparatus 1009, or installed from the storage apparatus 1003, or installed from the ROM 1002. When the computer program is executed by the processing apparatus 1001, the above-mentioned functions defined in the method of the disclosed embodiments of the present application are executed.

The display control device for the LED display screen provided by the present application adopts the display control method for the LED display screen in the above embodiment and can solve the technical problem of the relatively single display of LED display screens in the related art. Compared with the related art, the beneficial effects of the display control device for the LED display screen provided by the present application are the same as those of the display control method for the LED display screen provided by the above embodiment. Other technical features in the display control device for the LED display screen are the same as those disclosed in the method of the previous embodiment, which will not be repeated here.

It should be understood that each part of the present application can be implemented by hardware, software, firmware, or a combination thereof. In the description of the above embodiments, specific features, structures, materials, or characteristics can be combined in any appropriate way in any one or more embodiments or examples.

The above descriptions are only specific implementations of the present application, but the scope of the present application is not limited thereto. Those skilled in the art can easily think of changes or substitutions within the technical scope disclosed in the present application, which should be covered in the scope of the present application. Therefore, the scope of the present application should be based on the scope of the claims.

The present application provides a computer-readable storage medium with computer-readable program instructions (i.e., a computer program) stored thereon. The computer-readable program instructions are used to execute the display control method for the LED display screen in the above embodiment.

The computer-readable storage medium provided by the present application may be a USB flash drive, but is not limited to an electrical, magnetic, optical, electromagnetic, infrared, or semiconductor system, system, or device, or any combination thereof. More specific examples of the computer-readable storage medium include, but are not limited to: an electrical connection with one or more wires, a portable computer disk, a hard disk, a random access memory (RAM), a read-only memory (ROM), an erasable programmable read-only memory (EPROM), an optical fiber, a portable compact disk read-only memory (CD-ROM), an optical storage device, a magnetic storage device, or any appropriate combination of the above. In this embodiment, the computer-readable storage medium may be any tangible medium containing or storing a program. The program may be used by or in combination with an instruction execution system, system, or device. The program code contained on the computer-readable storage medium can be transmitted through any appropriate medium, including but not limited to: an electric wire, an optical cable, radio frequency (RF), etc., or any appropriate combination of the above.

The above-mentioned computer-readable storage medium may be included in the display control device for the LED display screen; or it may exist independently without being assembled into the display control device for the LED display screen.

The above-mentioned computer-readable storage medium carries one or more programs. When the above-mentioned one or more programs are executed by the display control device for the LED display screen, the display control device for the LED display screen is made to: obtain the pixel value of the LED display screen; determine the pixel density mask set representing different lighting states of the LED display screen based on the pixel value; scan the to-be-displayed pattern using each pixel density mask in the pixel density mask set to obtain the target display pattern; and control the LED display screen to perform graduation display through the target display pattern.

The computer program code for executing the operations of the present application can be written in one or more programming languages or a combination thereof. The above programming languages include object-oriented programming languages, such as Java, Smalltalk, C++, and also include conventional procedural programming languages, such as “C” language or similar programming languages. The program code can be executed entirely on the user's computer, partially on the user's computer, as an independent software package, partially on the user's computer and partially on a remote computer, or entirely on the remote computer or server. In the case of a remote computer, the remote computer can be connected to the user's computer through any type of network, including a local area network (LAN) or a wide area network (WAN), or it can be connected to an external computer (for example, through the Internet using an Internet service provider).

The flowcharts and block diagrams in the accompanying drawings illustrate the possible implementation architectures, functions, and operations of the systems, methods, and computer program products according to various embodiments of the present application. In this regard, each block in the flowchart or block diagram may represent a module, a program segment, or a part of code. The module, program segment, or part of code contains one or more executable instructions for implementing the specified logical function. It should also be noted that in some alternative implementations, the functions marked in the blocks may occur in a different order from that marked in the accompanying drawings. For example, two consecutively represented blocks may actually be executed substantially in parallel, or they may sometimes be executed in the reverse order, depending on the involved functions. It should also be noted that each block in the block diagram and/or flowchart, and the combination of blocks in the block diagram and/or flowchart, can be implemented by a dedicated hardware-based system that executes the specified functions or operations, or by a combination of dedicated hardware and computer instructions.

The modules involved in the embodiments described in the present application can be implemented in software or hardware. The name of the module does not constitute a limitation on the module itself in some cases.

The readable storage medium provided by the present application is a computer-readable storage medium. The computer-readable storage medium stores computer-readable program instructions (i.e., a computer program) for executing the above display control method for the LED display screen. It can solve the technical problem of the relatively single display of LED display screens in the related art. Compared with the related art, the beneficial effects of the computer-readable storage medium provided by the present application are the same as those of the display control method for the LED display screen provided by the above embodiment, which will not be repeated here.

The present application also provides a computer program product, including a computer program. The computer program implements the steps of the above display control method for the LED display screen when executed by a processor.

The computer program product provided by the present application can solve the technical problem of the relatively single display of LED display screens in the related art. Compared with the related art, the beneficial effects of the computer program product provided by the present application are the same as those of the display control method for the LED display screen provided by the above embodiment, which will not be repeated here..

What is claimed is:

1. A display control method for an LED display screen, comprising:
obtaining a pixel value of the LED display screen;
determining a pixel density mask set representing different lighting states of the LED display screen based on the pixel value;
scanning a pattern to be displayed through each of pixel density masks in the pixel density mask set to obtain a target display pattern; and
controlling the LED display screen to perform a graduation display through the target display pattern.

2. The method according to claim 1, wherein the determining the pixel density mask set representing the different lighting states of the LED display screen based on the pixel value comprises:
determining a number of lit pixels through the pixel value;
classifying lighting states of the display screen based on the number of the lit pixels to obtain multiple lighting states of the display screen; and
constructing the pixel density mask set through the multiple lighting states of the display screen.

3. The method according to claim 1, wherein the scanning the pattern to be displayed through each of the pixel density masks in the pixel density mask set to obtain the target display pattern comprises:
obtaining summarized pixel coordinates based on each of the pixel density masks in the pixel density mask set;
scanning each of points in the pattern to be displayed through the pixel density mask and comparing pixels at same positions in the pattern to be displayed and the summarized pixel coordinates;
in response to that the pixel value of the corresponding pixel on the pattern to be displayed is a first value, using the pixel as a display pixel, wherein the first value indicates that the pixel is displayed in a first state;
in response to that the pixel value of the corresponding pixel on the pattern to be displayed is a second value, skipping scanning the pixel until the scanning is completed to obtain a display pixel set, wherein the second value indicates that the pixel is displayed in a second state, and the first state is different from the second state; and
obtaining the target display pattern through the display pixel set.

4. The method according to claim 1, wherein the obtaining the pixel value of the LED display screen comprises:
obtaining original pixels of the LED display screen;
dividing the original pixels to obtain multiple groups of divided pixels;
locating the multiple groups of the divided pixels based on a preset point-drawing function to obtain positions of the divided pixels; and
determining the pixel value of the LED display screen through the positions of the divided pixels.

5. The method according to claim 4, wherein the locating the multiple groups of the divided pixels based on the preset point-drawing function to obtain the positions of the divided pixels comprises:
locating each group of divided pixels in the multiple groups of the divided pixels based on the preset point-drawing function to obtain coordinates of the divided pixels; and
obtaining the positions of the divided pixels through the coordinates of the divided pixels.

6. The method according to claim 4, wherein the determining the pixel value of the LED display screen through the positions of the divided pixels comprises:
obtaining a preset value recording rule;
traversing the positions of the divided pixels to obtain different numbers of lit pixels in each group of divided pixels; and
recording a pixel value of a number of lit pixels based on the preset value recording rule to obtain the pixel value of the LED display screen.

7. The method according to claim 1, wherein the controlling the LED display screen to perform the graduation display through the target display pattern comprises:
obtaining a display instruction;
determining a density display timing sequence based on the display instruction; and
controlling display patterns with different display densities in the target display pattern to sequentially perform the graduation display on the LED display screen through the density display timing sequence.

8. A display control apparatus for an LED display screen, comprising:
an obtain module configured to obtain a pixel value of the LED display screen;
a determination module configured to determine a pixel density mask set representing different lighting states of the LED display screen based on the pixel value;
a scanning module configured to scan a to-be-displayed pattern through each of pixel density masks in the pixel density mask set to obtain a target display pattern; and
a display module configured to control the LED display screen to perform a graduation display through the target display pattern.

9. A display control device for an LED display screen, comprising a memory, a processor, and a computer program stored on the memory and operable on the processor, wherein when the computer program is executed by the processor, the display control method for the LED display screen of claim 1 is implemented.

10. A storage medium, wherein the storage medium is a computer-readable storage medium, and a computer program is stored on the storage medium, and when the computer program is executed by a processor, the display control method for the LED display screen of claim 1 is implemented.
